(19) United States
(12) Patent Application Publication
(10) Pub. No.: US 2012/0216566 A1
(43) Pub. Date: Aug. 30, 2012

(54) METHOD FOR IDENTIFYING GLASS DEFECT SOURCE, FUSION CAST REFRACTORY AND GLASS MELTING FURNACE USING IT

(75) Inventors: Toshihiro Ishino, Tokyo (JP); Yukihiro Ushimaru, Tokyo (JP); Shinya Hayashi, Tokyo (JP); Jean-Pierre Meynckens, Moustier (BE)

(73) Assignees: AGC GLASS EUROPE, BRUXELLES (WATERMAEL-BOITSFORT) (BE); AGCC, TOKYO (JP)

(21) Appl. No.: 13/505,206

(22) PCT Filed: Oct. 21, 2010
(86) PCT No.: PCT/EP2010/065898

§ 371 Date: Apr. 30, 2012

(30) Foreign Application Priority Data
Oct. 29, 2009 (JP) 2009-249346

(51) Int. Cl. C03B 5/43; C03B 5/00; C04B 35/49; C04B 35/10; C04B 35/48

(52) U.S. Cl. 65/29.12; 501/104; 65/374.13

(57) ABSTRACT

The present invention provides a method for identifying a glass defect source, whereby a glass defect source can directly be identified without using a mathematical simulation. The method for identifying a glass defect source, which comprises a step of constructing a glass melting furnace by using, as lining furnace material, a fusion cast refractory containing at least one tracer component selected from Cs₂O, SrO, BaO and ZnO, a step of melting a glass material by the glass melting furnace and forming the molten glass material to produce glass products, and a step of extracting one having a glass defect from the glass products and analyzing its component composition to determine the position of a glass defect source in the glass melting furnace.

The present invention relates to a method for identifying a glass defect source, which is used at the time of producing glass products by using a glass melting furnace, a fusion cast refractory and a glass melting furnace using it, and particularly, it relates to a method for identifying a glass defect source, whereby a glass defect caused by solution of a fused cast refractory component into molten glass, can be directly identified, and a fusion cast refractory and glass melting furnace suitably useful for such a method.

Commercially available main glasses may generally be classified by their compositions into soda lime glass, aluminosilicate glass, borosilicate glass, etc. These glasses are used as materials at the time of producing glass products, and industrially, such a glass material is melted in a glass melting furnace lined with a furnace material made of a refractory, and then, the molten glass material is formed, cooled and annealed for solidification to obtain a glass product.

As such a refractory, a fusion cast refractory is usually used which is obtainable in such a manner that refractory raw materials with a prescribed composition are completely melted, then cast into a mold having a predetermined shape and gradually cooled to room temperature for resolidification. This refractory is a highly corrosion-resistant refractory, as is totally different in both the structure and the production method from a bound refractory obtained by molding powdery or granular raw materials into a predetermined shape, followed by firing or not followed by firing.

As such fusion cast refractories, an alumina/zirconia/silica fusion cast refractory, an alumina fusion cast refractory, a zirconia fusion cast refractory, etc. are known as typical ones. For example, an alumina/zirconia/silica fusion cast refractory is usually called an AZS fusion cast refractory and is widely used as a refractory for glass melting.

The AZS fusion cast refractory comprises from about 80 to 85% (mass %, the same applies hereinafter unless otherwise specified) of a crystal phase and from 15 to 20% of a matrix glass phase filling spaces among such crystals. The crystal phase comprises corundum crystals and baddeleyite crystals, and its composition roughly comprises, in a commercial product, from 45 to 52% of Al₂O₃, from 28 to 41% of ZrO₂, from 12 to 16% of SiO₂ and from 1 to 1.9% of Na₂O.

As is well known, ZrO₂ undergoes a transformation expansion due to a phase transition between monoclinic crystal and tetragonal crystal in the vicinity of 1,150° C. during temperature rise or in the vicinity of 850° C. during temperature drop and thus shows abnormal shrinkage or expansion. The matrix glass phase plays a role as a cushion between the crystals, and it absorbs a stress by the transformation expansion due to a tetragonal-to-monoclinic transition of zirconia at the time of producing the AZS fusion cast refractory and thus performs an important role to produce a refractory free from cracking.

However, such a fusion cast refractory is constantly exposed to a high temperature during its use, and the portion in contact with molten glass material will be corroded, thus leading to a phenomenon, so-called glass exudation phenomenon, wherein the matrix glass phase exudes into the molten glass material. Such a glass exudation phenomenon is considered to take place as the viscosity of the matrix glass phase lowers to gain flowability at the high temperature and at the same time, the matrix glass phase is pushed out by a force of a gas evolved at the high temperature from the AZS fusion case refractory.

The glass composition thus exudation on the surface of the refractory is a highly viscous glass rich in alumina and zirconia, and when included in mother glass, it will not be completely diffused in the molten glass and tends to remain as a foreign inclusion and thus becomes a glass defect so-called knots or cord.

Such a glass defect is industrially a serious problem, since it decreases the yield of the product. Therefore, it has been attempted to improve the yield by identifying such a glass defect-forming portion and properly selecting the furnace material to be employed or an operation condition such as a temperature control.

However, such a glass defect-forming situation has an independent characteristic depending upon each melting furnace and is further different also depending upon e.g. operation conditions, and thus, the defect forming situation takes a complicated form. Therefore, in order to prevent formation of such a glass defect, identification of the defect-forming source and determination of the operation conditions or the structure of the glass melting furnace, have heretofore been carried out by utilizing a mathematical simulation.

As a method by such a mathematical simulation, a particle tracking method is, for example, known wherein in a glass melting furnace having a plurality of flow paths (lines) for glass melt, if melting defects get centered in a certain specific line, a plurality of particles are disposed in the line in question, and trails of the particles are tracked back in time, whereby the defect-forming source is estimated from the streamlines.

Further, as an improvement of such a particle tracking method, a method is known wherein a flow-field of glass melt in a glass melting furnace is determined, and with respect to such a flow-field, a virtual tracer component is generated at an outlet to a specific flow line, whereby an advection-diffusion equation in consideration solely of the advection flow relating to the tracer component in the flow-field of the glass melt, is set, and this advection-diffusion equation is solved in an inverse time direction to obtain a concentration distribution of the tracer component, from which an inflow probability distribution of the tracer component into the specific flow line is obtained, and based on such an inflow probability distribution, the position of the melting defect source is identified (JP-A-2000-7342).

Further, as a refractory to be used for a melting furnace, a fusion cast refractory comprising SrO, BaO and ZnO is known although such a refractory is not one to identify a glass defect source (Japanese Patents No. 2,870,188 and No. 4,297,543, JP-A-2001-220249).

However, identification of the position of a defect source such as knots or cord, by the above mathematical simulation has had a problem that the operation is cumbersome, since the flow of glass melt is analyzed, and in the flow, a tracer component or particles are introduced, so that the in-flow portion of the defect source is estimated and identified by e.g. probability. Further, such a mathematical simulation is one to identify the defect source indirectly and thus has a problem that the accuracy is low. Therefore, there was a case where the glass defect-forming situation did not change even when the problem of the portion estimated to be the defect source was removed.

Accordingly, the present invention has been made to solve the above problems, and it is an object of the present invention to provide a method for identifying a glass defect source, whereby the glass defect source can be directly identified without using a mathematical simulation.

The method for identifying a glass defect source of the present invention comprises:

a step of constructing a glass melting furnace by using, as lining furnace material, a fusion cast refractory containing at least one tracer component selected from the group consisting of Cs₂O, SrO, BaO and ZnO,

a step of melting a glass material by the glass melting furnace and forming the molten glass material to produce glass products, and

a step of extracting one having a glass defect from the glass products and analyzing its component composition to determine the position of a glass defect source in the glass melting furnace.

As the lining furnace material to be used here, an alumina/zirconia/silica fusion cast refractory, an alumina fusion cast refractory and a zirconia fusion cast refractory may be mentioned as typical ones.

The alumina/zirconia/silica fusion cast refractory of the present invention is one which has a chemical composition comprising, by mass %, from 45 to 70% of Al₂O₃, from 14 to 45% of ZrO₂, from 9 to 15% of SiO₂, and at most 2% of a total amount of Na₂O, K₂O, Cs₂O and SrO and which contains from 0.2 to 2% of at least one tracer component selected from Cs₂O and SrO.

The alumina fusion cast refractory of the present invention is one which has a chemical composition comprising, by mass %, from 94 to 98% of Al₂O₃, from 0.1 to 1.0% of SiO₂, and at most 5% of a total amount of Na₂O, K₂O, Cs₂O, SrO, BaO and ZnO and which contains from 0.2 to 5% of at least one tracer component selected from Cs₂O, SrO, BaO and ZnO.

The zirconia fusion cast refractory of the present invention is one which has a chemical composition comprising, by mass %, from 88 to 97% of ZrO₂, from 2.4 to 10.0% of SiO₂, from 0.4 to 3% of Al₂O₃ and at most 1% of a total amount of Na₂O, K₂O and Cs₂O and which contains from 0.2 to 0.5% of a tracer component of Cs₂O.

Further, the glass melting furnace of the present invention is one using at least one fusion cast refractory selected from the alumina/zirconia/silica fusion cast refractory, the alumina fusion cast refractory and the zirconia fusion cast refractory of the present invention.

According to the method for identifying a glass defect source of the present invention, a fusion cast refractory containing at least one tracer component selected from Cs₂O, SrO, BaO and ZnO, is used as lining furnace material of the glass melting furnace, whereby it is possible to easily and directly identify which portion of the glass melting furnace becomes a glass defect source.

Each fusion cast refractory of the present invention and the glass melting furnace using it are suitable for the method for identifying a glass defect source of the present invention.

Firstly, the method for identifying a glass defect source of the present invention will be described.

In this method for identifying a glass defect source, firstly, a glass melting furnace is constructed in which a fusion cast refractory containing at least one tracer component selected from Cs₂O, SrO, BaO and ZnO is used as lining furnace material for the glass melting furnace. At that time, one containing the above tracer component is provided at the portion where the lining furnace material will be in contact with molten glass.

Here, the fusion cast refractory to be used as liner furnace material for the glass melting furnace is one containing at least one tracer component selected from Cs₂O, SrO, BaO and ZnO, and as such a refractory, an alumina/zirconia/silica fusion cast refractory, an alumina fusion cast refractory or a zirconia fusion cast refractory is mentioned as a typical one.

In a case where only one type of fusion cast refractory is used for the construction of the glass melting furnace, such a fusion cast refractory containing a tracer component is used for a part of the glass melting furnace where a glass defect may possibly be formed. If it is used for the entire furnace, it eventually becomes impossible to identify a defect source. In this case, a conventional fusion cast refractory containing no tracer component may be used for the portion which has no possibility of becoming a glass defect source.

In a case where two or more fusion cast refractories containing tracer components are to be used, portions which may possibly become glass defect sources, are constructed by fusion cast refractories having different tracer components, respectively. Here, in a case where one of Cs₂O, SrO, BaO and ZnO is used alone, the different tracer components mean different types thereof, and in a case where two or more of such components are used in combination as tracer components, the difference tracer components mean ones wherein the types and/or contents of the tracer components contained, are different, and they are ones which can be distinguished from one another in the after-mentioned compositional analysis.

Accordingly, the glass melting furnace to be used here is preferably constructed by dividing the glass melting furnace into optional block units and using a fusion cast refractory having a different tracer component for every block unit.

And, then, glass material is melted by the so-constructed glass melting furnace, and the molten glass material is transferred as melted in the furnace and molded, cooled and solidified at a prescribed place to produce a desired glass product, in the same manner as the production of a usual glass product.

Then, the obtained glass product is inspected to see whether or not a glass defect is formed, and one wherein a glass defect is formed, is extracted, whereupon with respect to the extracted glass product, the composition of glass components at the defect portion is analyzed. Such a composition analysis can be carried out by e.g. an electron microscopic analysis (SEM-EDX, EPMA), a fluorescent X-ray analysis, an electronic absorption spectrometry or an ICP (inductively coupled plasma) emission analysis, an ICP mass spectrometry, etc. Here, the tracer component contained in the fusion cast refractory is preferably at least 0.2% so that the tracer component can be detected sufficiently.

As a result of the analysis, by analyzing whether or not the tracer component is contained, and if contained, which tracer component is contained, it is possible to identify a glass defect source in the glass melting furnace. That is, such a glass defect source can easily and directly be identified to be the portion where the lining furnace material containing the tracer component detected by the analysis is used. Here, at the time of analyzing the composition, it is necessary to take into consideration the glass material used, the presence or absence of the tracer component and the content of the tracer component.

Firstly, a case where the glass material used contains no tracer component, will be described. In such a case, the conclusion is easy, namely, if a tracer component is detected by the composition analysis for a glass defect, it can be ascertained that the portion constituted by the fusion cast refractory containing the detected tracer component is the defect source. On the contrary, if the tracer component is not detected, it can be stated that a portion other than the fusion cast refractory containing the tracer component is the glass defect source.

Next, a case where the glass material used contains a tracer component, will be described. In such a case, the tracer component is always detected, and therefore, it is important to quantify the detected tracer component by the composition analysis for a glass defect.

Even if a tracer component is detected, if the detected amount is not different from the proportion in the glass material used, it can be stated that a portion other than the fusion cast refractory containing the tracer component is the glass defect source. On the other hand, if the detected amount is sufficiently large beyond the proportion in the glass material used, for example, if the difference is at least 1 mass %, it is possible to determine that a portion constituted by the fusion cast refractory containing the tracer component is the defect source. In such a case where the tracer component is contained in the glass material, it is possible to facilitate the analysis and quantification by increasing the content of the tracer component contained in the fusion cast refractory.

Fusion cast refractories suitable for the method for identifying a glass defect source of the present invention will be described below.

The fusion cast refractories of the present invention are an alumina/zirconia/silica fusion cast refractory, an alumina fusion cast refractory and a zirconia fusion cast refractory, and they are ones constituted by the above-described components, respectively. Each of such components will be described below. Here, in this specification, the contents of components are based on the refractory, and “%” means mass %.

Firstly, the respective components of the alumina/zirconia/silica fusion cast refractory, hereinafter referred to as the AZS fusion cast refractory, is described.

The Al₂O₃ component in the AZS fusion cast refractory is an important component like ZrO₂ among components constituting the crystal structure of the refractory, and it constitutes a corundum crystal and thus exhibits a strong corrosion resistance next to ZrO₂ against molten glass, but does not exhibit transformation expansion like ZrO₂. Its blend amount is preferably within a range of from 45 to 70%. If it exceeds 70%, the amount of the matrix glass phase becomes small, and at the same time, mullite (3Al₂O₃·SiO₂) is likely to form, whereby it tends to be difficult to product the refractory without cracking. On the other hand, if it is too small at a level of less than 45%, the amount of the matrix glass phase becomes large, whereby glass tends to exude.

The ZrO₂ component in the AZS fusion cast refractory has a strong resistance against corrosion by molten glass and is an essential component of the refractory. From such a viewpoint, its content should better be large, but in the present invention, if the ZrO₂ content becomes large, the transformation expansion of ZrO₂ and the resulting stress tend to be so large that the matrix glass phase may not be able to absorb the volume change and it becomes difficult to produce the refractory without cracking. On the other hand, if its content is too small, the corrosion resistance against molten glass tends to be poor. Therefore, the blend amount of the ZrO₂ component is preferably within a range of from 14 to 45%.

The SiO₂ component is a main component constituting the matrix glass phase and is an important component influential over the properties. Its blend amount is preferably within a range of from 9 to 15%. If it is less than 9%, the amount of the matrix glass phase becomes small, whereby the matrix glass phase may not be able to absorb the volume change of ZrO₂, and it becomes difficult to produce the refractory without cracking. On the other hand, if it exceeds 15%, the amount of the matrix glass phase becomes large, and it is easy to exude the matrix glass.

Na₂O and K₂O being alkali components, are important components to adjust the relation between the temperature and the viscosity of the matrix glass phase. If the total amount of their contents exceeds 1.8%, it is easy to exude the matrix glass. On the other hand, if the total amount is less than 0.8%, the viscosity of the matrix glass phase tends to be too high, and at the same time, mullite is likely to form, whereby it becomes difficult to produce the refractory without cracking.

And, in the present invention, at least one of Cs₂O and SrO is contained as a tracer component to identify a glass defect source. Here, the above compounds are selected as the tracer components for such a reason that when the matrix glass exudes and is mixed in molten glass material, they are sufficiently dissolved in the matrix glass and can transfer to the glass material side.

Here, such Cs₂O, SrO, BaO and ZnO components are ones such that the total amount including Na₂O and K₂O i.e. the total amount of Na₂O, K₂O, Cs₂O and SrO is at most 2%, and the Cs₂O and SrO components are contained in an amount of at least 0.2%. If the tracer component is less than 0.2%, the detection performance tends to be poor, and identification of the glass defect source tends to be difficult.

Other components may be contained to such an extent not to impair the desired effects of the present invention, but their amounts are preferably limited to be as small as possible.

For example, Fe₂O₃, TiO₂, CaO and MgO are included as impurities in industrial raw materials, and their contents should better be as small as possible. However, even if they are contained in a range of from 0.05 to 0.4% in their total amount, as an industrial range, they are not influential over the properties. Consequently, the total content of the components is 100%.

The respective components of the alumina fusion cast refractory of the present invention will be described.

The Al₂O₃ component in the alumina fusion cast refractory is an important component among components constituting the crystal structure of the refractory and has a structure wherein αAl₂O₃ (corundum crystal) and βAl₂O₃ crystal formed by reaction with alkali are complexed. It exhibits a strong corrosion resistance against molten glass and at the same time shows no transformation expansion. Its blend amount is preferably within a range of from 94 to 98%. If it exceeds 98%, the βAl₂O₃ crystal phase tends to be small, and cracking is likely to take place. On the other hand, if it is too small at a level of less than 94%, the βAl₂O₃ crystal phase increases and the porosity becomes at least a few %, whereby the corrosion resistance against molten glass deteriorates, such being undesirable.

SiO₂ is an essential component to form a matrix glass to relax a stress formed in the refractory. Such SiO₂ is required to be contained in an amount of at least 0.1% in the refractory in order to obtain a refractory having a practical size free from cracks, and it is preferably contained in an amount of at least 0.5%. However, if the content of the SiO₂ component becomes large, the corrosion resistance tends to be small. Therefore, in the present invention, SiO₂ is contained within a range of from 0.1 to 1.0% in the refractory.

Na₂O and K₂O being alkali components are important components which react with Al₂O₃ to form βAl₂O₃ crystal. If the total amount of their contents exceeds 4.8%, the βAl₂O₃ crystal phase increases and the porosity becomes at least a few %, whereby the corrosion resistance against molten glass deteriorates, such being undesirable. On the other hand, if the total amount is less than 1%, the βAl₂O₃ crystal phase becomes less, and cracking is likely to take place.

And, in the present invention, at least one of Cs₂O, SrO, BaO and ZnO is contained as a tracer component to identify a glass defect source. Here, such compounds are selected as tracer components for such a reason that the tracer component and Al₂O₃ are reacted to constitute βAl₂O₃ or the matrix glass composition, and when contacted with molten glass at a high temperature, they are mixed in the molten glass material and thus can transfer to the glass material side.

Here, such Cs₂O, SrO, BaO and ZnO components are ones such that the total amount including Na₂O and K₂O i.e. the total amount of Na₂O, K₂O, Cs₂O, SrO, BaO and ZnO is at most 5%, and the Cs₂O, SrO, BaO and ZnO components are contained in an amount of at least 0.2%. If the tracer component is less than 0.2%, the detection performance becomes poor, and it becomes difficult to identify a glass defect source.

Other components may be contained to such an extent not to impair the desired effects of the present invention, but their amounts are preferably limited to be as small as possible.

For example, Fe₂O₃, TiO₂, CaO and MgO are included as impurities in industrial raw materials, and their contents should better be as small as possible. However, even if they are contained in a range of from 0.05 to 0.4% in their total amount, as an industrial range, they are not influential over the properties. Consequently, the total content of the components is 100%.

The respective components of the zirconia fusion cast refractory will be described.

ZrO₂ has a strong resistance against corrosion by molten glass and is contained as a main component of the refractory. Accordingly, the larger the content of ZrO₂ in the refractory, the better the corrosion resistance against molten glass, and in the zirconia fusion cast refractory, the content of ZrO₂ is at least 88% in order to obtain sufficient corrosion resistance against molten glass.

On the other hand, if the content of ZrO₂ exceeds 97%, the amount of the matrix glass becomes relatively small, whereby it becomes impossible to absorb the volume change resulting from the transformation of baddeleyite crystal and it becomes difficult to obtain a refractory free from cracks. Therefore, in the present invention, ZrO₂ is contained within a range of from 88 to 97% in the refractory.

SiO₂ is an essential component to form a matrix glass to relax a stress formed in the refractory. Such SiO₂ is required to be contained at least 2.4% in the refractory in order to obtain a refractory having a practical size free from cracks, and it is preferably contained in an amount of at least 5.0%. However, if the content of the SiO₂ component becomes large, the corrosion resistance becomes small. Therefore, in the present invention, SiO₂ is contained within a range of from 2.4 to 10.0% in the refractory.

Al₂O₃ has an important role to adjust the relation between the temperature and the viscosity of the matrix glass and has an effect to reduce the concentration of the ZrO₂ component in the matrix glass. In order to suppress formation of a crystal such as zircon (ZrO₂·SiO₂) in the matrix glass by utilizing such an effect, the content of the Al₂O₃ is required to be at least 0.4%. Further, in order to maintain the viscosity of the matrix glass at a proper level in a crystal transformation temperature range of baddeleyite crystal, the content of the Al₂O₃ component is required to be at most 3.0%. Therefore, in the present invention, Al₂O₃ is contained in a range of from 0.4 to 3% in the refractory.

If the Al₂O₃ component exceeds 3%, not only the viscosity of the matrix glass becomes high, but also the Al₂O₃ component tends to react with SiO₂ to form mullite. In such a case, not only the absolute amount of the matrix glass decreases, but also the viscosity of the matrix glass becomes high due to the precipitated mullite crystal, thus leading to residual volume expansion. If such residual volume expansion accumulates by thermal cycle, cracks will be formed in the refractory, and the anti-thermal cycle stability will be impaired. Therefore, in order to suppress precipitation of mullite in the matrix glass and to distinctly reduce the accumulation of the residual volume expansion, the content of Al₂O₃ component is preferably at most 2%.

Na₂O and K₂O being alkali components, are important components to adjust the relation between the temperature and the viscosity of the matrix glass phase. If the total amount of their contents exceeds 0.8%, glass is likely to leak out. On the other hand, if the total amount is less than 0.1%, the viscosity of the matrix glass phase becomes too high, whereby it becomes impossible to produce the refractory without cracking.

And, in the present invention, Cs₂O is contained as a tracer component to identify a glass defect source. Here, such a compound is selected as the tracer component for such a reason that when the matrix glass leaks out and is mixed in a molten glass material, it is sufficiently dissolved in the matrix glass and thus can transfer to the glass material side.

Here, such Cs₂O component is one such that the total amount including Na₂O and K₂O i.e. the total amount of Na₂O, K₂O and Cs₂O is at most 1%, and the Cs₂O component is contained in an amount of from 0.2% to 0.5%. If the tracer component becomes less than 0.2%, the detection performance tends to be poor, and it becomes difficult to identify a glass defect source.

Other components may be contained to such an extent not to impair the desired effects of the present invention, but their contents are preferably limited to be as small as possible.

For example, Fe₂O₃, TiO₂, CaO and MgO are included as impurities in industrial raw materials, and their contents should better be as small as possible. However, even if they are contained in a range of from 0.05 to 0.4% in their total amount, as an industrial range, they are not influential over the properties. Consequently, the total content of the components is 100%.

Each of the above-described fusion cast refractories is produced in such a manner that powder raw materials are homogeneously mixed so that they become the above-described blend ratio, then the mixture is melted by an arc electric furnace, and the melted material is cast into a graphite mold, followed by cooling. Such a refractory is superior in anti-corrosion stability to a sintered refractory, since the obtained crystal structure is dense and the crystal size is large, although it requires a cost since the energy required for melting is large. Here, heating at the time of melting is carried out by contacting the raw material powder with a graphite electrode and applying an electric current to the electrode.

The refractory thus obtained exhibits excellent corrosion resistance against molten glass and is one suitable as a furnace material for a glass melting furnace to be used for the production of a glass product such as plate glass.

The glass melting furnace of the present invention is one produced by using the above-described fusion cast refractory of the present invention and may be produced by using the fusion cast refractory of the present invention as lining furnace material.

Further, in the production of such a glass melting furnace, as mentioned above, it is preferred that the glass melting furnace is constructed by dividing it into optional block units and using a fusion cast refractory having a different tracer component for every block unit as liner furnace material. At that time, for the block unit which is not considered to be a glass defect source, a conventional fusion cast refractory containing no tracer component may be employed.

Here, how block units should be divided, and what types of fusion cast refractories should be used for which block units, are preferably determined by estimating the flow path of glass melt in the designing stage so that a glass defect source can be efficiently identified.

### EXAMPLES

The alumina/zirconia/silica fusion cast refractory of the present invention will be described more in detail with reference to Examples. However, it should be understood that the present invention is not limited to these Examples.

### Example 1

Powder materials of the respective components were homogeneously mixed in the blend ratio as shown in Table 1, and the mixture was melted by an arc electric furnace. The melted material was cast into a graphite mold, followed by cooling to obtain an AZS fused cast brick of a class with a zirconia content of 32%. This brick was one containing 0.43% of Cs₂O as a tracer component.

From the obtained fused cast brick, a cuboid test specimen of 10 mm×20 mm×120 mm was cut out, and a corrosion test was carried out by hanging it in a platinum crucible having plate glass melted, at 1,500° C. for 72 hours, whereby the corrosion of the fused cast brick was measured, and at the same time, the Cs₂O content in the glass in the vicinity of the brick was examined. Further, separately, a test specimen of 30 mm (diameter)×30 mm (height) was cut out from the obtained fused cast brick, and this test specimen was heated in an electric furnace at 1,500° C. for 16 hours, whereupon the amount of glass exudation was obtained. The results are shown in Table 1.

### Example 2

A fused cast brick was cast in the same manner as in Example 1 except that it was made to contain 0.48% of SrO instead of Cs₂O as the tracer component, and the corrosion by glass, the SrO content and the amount of glass exudation were examined. The results are shown in Table 1.

### Example 3

One having a Cs₂O content of 2.1% as the tracer component, was cast in the same manner in Example 1. In the same manner as in Example 1, the corrosion by glass, the SrO content and the amount of glass exudation were examined, and the results are shown in Table 1.

### Comparative Examples 1 and 2

A usual AZS fused cast brick not containing Cs₂O or SrO as a tracer component (Comparative Example 1) and one with a Cs₂O content of 0.19% (Comparative Example 2) were cast in the same manner as in Example 1. In the same manner as in Example 1, the corrosion by glass, the SrO content and the amount of glass exudation were examined, and the results are shown in Table 1.

TABLE 1

| | | Examples | | | Comparative Examples | |
|---|---|---|---|---|---|---|
| | | 1 | 2 | 3 | 1 | 2 |
| Chemical | ZrO₂ | 33.7 | 34 | 33 | 32.9 | 34.7 |
| components | Al₂O₃ | 53 | 52.3 | 52.7 | 52.9 | 52.4 |
| of brick | SiO₂ | 12 | 12.4 | 11 | 12.7 | 11.7 |
| (mass %) | Na₂O | 1.13 | 1.17 | 1.1 | 1.29 | 1.13 |
| | Cs₂O | 0.43 | 0 | 2.1 | 0 | 0.19 |
| | SrO | 0 | 0.48 | 0 | 0 | 0 |

| | | | | | |
|---|---|---|---|---|---|
| Content of tracer | 0.18 | 2.44 | 1.5 | 0 | 0 |
| component in glass in | | | | | |
| the vicinity of brick after | | | | | |
| corrosion test (mass %) | | | | | |
| Corrosion speed | 1.56 | 1.55 | 2.1 | 1.56 | 1.56 |
| (mm/day) | | | | | |
| Amount of glass | 2.1 | 1.6 | 4 | 1.8 | 1.8 |
| exudation (%) | | | | | |

* Corrosion of brick after corrosion test:

The corrosion resistance was obtained in such a manner that the cuboid test specimen of 10 mm×20 mm×120 mm was cut out from the fused cast brick and hanged in a platinum crucible and immersed in a glass material at 1,500° C. for 48 hours in a kanthal super furnace, whereupon the corrosion was measured. The glass material used here was one with a composition comprising 72.5% of SiO₂, 2.0% of Al₂O₃, 4.0% of MgO, 8.0% of CaO, 12.5% of Na₂O and 0.8% of K₂O.

*Content Of Tracer Component in Glass in the Vicinity of Brick After Corrosion Test:

In the above corrosion test, the component in glass at a portion distanced by from 0.5 to 1 mm from the surface layer of the test specimen immersed in the glass was measured by using an electron microscope (SEM-EDX).

*Amount of Glass Exudation:

A cylindrical specimen having a diameter of 30 mm and a height of 30 mm was cut out by a diamond core drill, and by an Archimedes method, the dry mass (W1) and the mass in water (W2) were measured. This test specimen was held at 1,500° C. for 16 hours in an electric furnace, then taken out from the furnace and permitted to cool naturally outside the furnace. With respect to this test specimen, by an Archimedes method, the dry mass (W3) and the mass in water (W4) were measured again. By using measured values thus obtained, the amount of glass exudation was calculated by the following formula (1).

Amount of glass exudation=[(W3−W4)/(W1−W2)−1]×100% (1)

As a result, in Examples 1 and 2, it was possible to detect Cs₂O and SrO in glass in the vicinity of the furnace material after the corrosion test for a long time of 72 hours at 1,500° C., and it was confirmed that the tracer component can be detected when it became a glass defect. Further, the corrosion resistance by the corrosion test and the glass exudation test results were confirmed to be not substantially different from the commonly used brick (Comparative Example 1). Further, also in Example 3, Cs₂O in glass in the vicinity of the furnace material after the corrosion test was sufficiently detectable at a level of 1.5%. However, in Example 3, the corrosion in the corrosion test and the amount of glass exudation were substantial, and if such a brick is used for a glass furnace, an adverse effect is likely to be given to a product.

On the other hand, in Comparative Example 2, the Cs₂O content was 0.19%, but Cs₂O was not detected in glass in the vicinity of the furnace material after the corrosion test.

From the foregoing, by the method for identifying a glass defect source of the present invention, it was possible to identify a glass defect source easily and directly.

The method for identifying a glass defect source of the present invention can be used in the field of production of glass products using a glass melting furnace. Further, the fusion cast refractory of the present invention and the glass melting furnace using it are suitable for carrying out the method for identifying a glass defect source of the present invention. However, they can also be applied to a glass melting furnace in the production of glass products wherein no such identifying method is carried out.

1. A method for identifying a glass defect source, comprising:
melting a glass material in a glass melting furnace to obtain a molten glass material wherein the furnace comprises a lining material, the lining material comprising a fusion cast refractory comprising at least one tracer component selected from the group consisting of Cs₂O, SrO, BaO and ZnO,
forming the molten glass material into glass products, and
selecting from the glass products one having a glass defect and analyzing its component composition to determine a position of a glass defect source in the glass melting furnace.

2. The method of claim 1, wherein the fusion cast refractory is at least one selected from the group consisting of an alumina/zirconia/silica fusion cast refractory, an alumina fusion cast refractory and a zirconia fusion cast refractory.

3. The method of claim 1, wherein the glass material to be melted comprises none of the tracer component.

4. The method of claim 1, wherein the glass melting furnace comprises portions divided into block units, and each block unit comprises a fusion cast refractory comprising a different tracer component from the tracer components in the other block units.

5. A furnace lining material comprising an alumina/zirconia/silica fusion cast refractory comprising, by mass %, 45 to 70% of Al₂O₃, 14 to 45% of ZrO₂, 9 to 15% of SiO₂, at most 2% of a total amount of Na₂O, K₂O, Cs₂O and SrO, and 0.2 to 2% of at least one tracer component selected from Cs₂O and SrO.

6. A furnace lining material comprising an alumina fusion cast refractory comprising, by mass %, 94 to 98% of Al₂O₃, 0.1 to 1.0% of SiO₂, at most 5% of a total amount of Na₂O, K₂O, Cs₂O, SrO, BaO and ZnO and 0.2 to 5% of at least one tracer component selected from Cs₂O, SrO, BaO and ZnO.

7. A furnace lining material comprising a zirconia fusion cast refractory composition comprising, by mass %, 88 to 97% of ZrO₂, 2.4 to 10.0% of SiO₂, 0.4 to 3% of Al₂O₃, at most 1% of a total amount of Na₂O, K₂O and Cs₂O, and 0.2 to 0.5% of a tracer component of Cs₂O.

8. A glass melting furnace comprising the furnace lining material of claim 5.

9. The glass melting furnace of claim 8, comprising portions divided into optional block units, and for every wherein each block unit comprises a fusion cast refractory comprising a different tracer component from the tracer components in the other block units.

10. A glass melting furnace comprising the furnace lining material of claim 6.

11. A glass melting furnace comprising the furnace lining material of claim 7.

12. The glass melting furnace of claim 10, comprising portions divided into block units, and each block unit comprises a fusion cast refractory comprising a different tracer component from the tracer components in the other block units.

13. The furnace lining material of claim 5, further comprising 0.05 to 0.4% by mass of a total amount of Fe₂O₃, TiO₂, CaO and MgO.

14. The furnace lining material of claim 6, comprising 0.5 to 1.0% by mass of SiO₂.

15. The furnace lining material of claim 6, comprising 1 to 4.8% by mass of a total amount of Na₂O and K₂O.

16. The furnace lining material of claim 6, further comprising 0.05 to

0. 4% by mass of a total amount of Fe₂O₃, TiO₂, CaO and MgO.

17. The furnace lining material of claim 7, comprising 5 to 10.0% by mass of SiO₂.

18. The furnace lining material of claim 7, comprising 0.4 to 2% by mass of Al₂O₃.

19. The furnace lining material of claim 7, comprising 0.1 to 0.8% by mass of a total amount of Na₂O and K₂O.

20. The furnace lining material of claim 7, further comprising 0.05 to 0.4% by mass of a total amount of Fe₂O₃, TiO₂, CaO and MgO.
